(19) United States
(12) Patent Application Publication
(10) Pub. No.: US 2024/0012841 A1
(43) Pub. Date: Jan. 11, 2024

(54) METHOD AND SYSTEM FOR INTEGRATED MONITORING OF CHATBOTS FOR CONCEPT DRIFT DETECTION

(71) Applicant: PwC Product Sales LLC, New York, NY (US)

(72) Inventors: Joseph David VOYLES, Louisville, KY (US); Siddhesh Shivaji ZANJ, Mumbai (IN); Prasang GUPTA, Mumbai (IN); Vishakha BANSAL, Mumbai (IN); Shantanu DEV, Chicago, IL (US)

(73) Assignee: PwC Product Sales LLC, New York, NY (US)

(21) Appl. No.: 18/348,793

(22) Filed: Jul. 7, 2023

Related U.S. Application Data
(60) Provisional application No. 63/359,636, filed on Jul. 8, 2022.

(51) Int. Cl. G06F 16/335; G06F 16/35; G06F 40/40

(52) U.S. Cl. CPC G06F 16/337; G06F 16/355; G06F 40/40

(57) ABSTRACT

An exemplary system and method are provided for monitoring concept drift in a trained model, such as a chatbot. The system is configured to perform a method including receiving a first dataset representing model operations executed by the trained model; applying a data processing operation to the first dataset to determine a first result data of the first dataset; determining, based on the first result data, a difference between the first result data and a second result data; determining, based on the difference, whether concept drift has occurred; and in accordance with a determination that concept drift has occurred, transmitting an instruction to update training of the trained model. The exemplary system may be implemented as a drift detection system in communication with the trained model.

### REFERENCE TO RELATED APPLICATIONS

This application claims the benefit of U.S. Provisional Application No. 63/359,636, filed Jul. 8, 2022, the entire contents of which is incorporated herein by reference.

### FIELD

The present disclosure relates generally to the analysis of data from trained models, such as chatbots, and more specifically to methods and systems for integrated monitoring of data from trained models for the monitoring and detection of concept drift in intent classifications associated with user input data to trained models.

### BACKGROUND

Trained models, such as chatbots, are increasingly used to provide services to users, such as by answering user questions, generating data based on user prompts, suggesting services to a user, and providing other model outputs. In order to provide the appropriate services to a user, trained models may employ an intent classification system that receives user queries (which may be expressed in natural language) and determines the intent of the user query based on the language of the query, the context of the query, information about the user, the past training data used to train the model, and other information.

### SUMMARY

As described above, classification models such as intent classification models for chatbots may be trained on labeled historical user conversations and used to sort present user queries into intent classes. As user queries change over time, the intent classifications used to determine a user's intent may drift and evolve responsive to the new and unexpected user queries, allowing the trained model to accommodate new types of user queries and provide additional services to users. Trained models may need retraining to adapt to these changing user queries and service and to ensure that the model's intent classification system continues to correctly classify user queries and provide the appropriate services to the user. For instance, new intent classifications may be needed, or existing intent classifications may need redefinition or refinement to best capture the full range of user queries received from users of the model. However, many existing trained models fail to monitor the drift and evolution of user queries and intent classifications over time, making it difficult to determine when additional retraining and updating of trained models is needed.

There is a need for systems and methods capable of monitoring and evaluating the way trained models classify user queries and how the intent classifications of user queries by a trained model change over time. Accordingly, disclosed herein are systems and methods integrated with a deployed trained model, such as a chatbot, that continuously monitor user queries and conversations with the trained model to determine drift and/or evolution in the model's predictions for the intent classification of user queries over time. The model or system may then notify or alert the administrators or developers of the model to take necessary actions based on the magnitude and character of the concept drift and/or concept evolution detected. In addition to this, the monitoring system and models may be used to identify new or modified intent classifications and update the deployed model by re-training the model on the new or modified intent classifications.

Accordingly, the systems and methods described herein are capable of monitoring trained models for drifting or evolving classification of user intents derived from user inputs into the trained model. Advantageously, the systems and methods described herein operate in a pipeline separate from the system of the trained models, allowing the detection of concept drift and concept evolution to be conducted in real-time and in parallel with the model's processing of user inputs. Trigger-based buffer management and drift detection pipelines operate separately from the core architecture of the trained model, allowing for parallel and real-time processing of data from the model. Thus, the monitoring of concept drift and evolution detection does not hamper the functioning of the trained model itself and does not require any downtime or disruption of the model's activity. Updating and retraining of the model may also proceed without restarting the server or requiring downtime of the model. Further, because the proposed concept drift and concept evolution pipelines operate independently from a trained model, the systems and method described herein may be easily integrated with a variety of trained model systems, such as any available chatbot systems.

In some examples, a method for monitoring concept drift in a trained model is provided, the method comprising: receiving a first dataset representing model operations executed by the trained model; applying a data processing operation to the first dataset to determine a first result data based on the first dataset; determining, based on the first result data, a difference between the first result data and a second result data; determining, based on the difference, whether concept drift has occurred; and in accordance with a determination that concept drift has occurred, transmitting an instruction to update training of the trained model.

In some examples, the data processing operation comprises a statistical analysis operation and wherein the first result data comprises a first statistical output.

In some examples, the statistical analysis operation comprises one or more of the following: a Kolmogorov-Smirnov (KS) test, a maximum mean discrepancy (MMD) test, a least-squares density difference (LSDD) test, a KMeans and chi square test, an equal intensity KMeans (EIKMeans) and chi square test, a Jensen-Shannon (JS) divergence test, and an uncertainty classifier.

In some examples, the data processing operation comprises a model error rate determination analysis and the first result data comprises a first error rate.

In some examples, the model error rate determination analysis comprises one or more of the following: Fisher's test, and a statistical test of equal proportions (STEPD).

In some examples, the first dataset comprises at least one of user input data, vector data representative of the user input data, and model output data.

In some examples, the user input data comprises natural language data.

In some examples, the model output data comprises an intent classification generated based on user input data of the first dataset.

In some examples, receiving the first dataset comprises receiving the first dataset from a shared memory in communication with the trained model.

In some examples, the first dataset comprises a predetermined amount of data.

In some examples, the first dataset comprises data received during a predetermined period of time.

In some examples, the method further comprises: receiving a second dataset representing model operations executed by the trained model; and applying a data processing operation to the second dataset to determine the second result data.

In some examples, the second dataset comprises a training dataset that was used to train the trained model.

In some examples, the second dataset comprises a dataset having a similar distribution to a training dataset that was used to train the trained model.

In some examples, the second dataset comprises an inference dataset processed by the trained model at a different time than the first dataset.

In some examples, the difference comprises a difference between a first characteristic of the first result data and a second characteristic of the second result data.

In some examples, the difference comprises a difference between a first determined number of clusters of the first dataset and a second determined number of clusters in a second dataset.

In some examples, determining whether concept drift has occurred comprises determining whether the difference is greater than a threshold value.

In some examples, transmitting the instruction to update training of the trained model comprises transmitting executable program code configured to cause the trained model to be retrained when the code is executed by one or more processors.

In some examples, the instruction comprises an indication of the character or magnitude of the detected concept drift.

In some examples, the method further comprises: retraining the trained model, wherein retraining the trained model comprises: applying one or more labels to data in the first dataset, the one or more labels associated with an intent classification of the data; and updating the trained model based at least in part on the labeled first dataset.

In some examples, the one or more labels applied to the data are determined based on a spatial clustering analysis of the first dataset.

In some examples, the trained model is a chatbot.

In some examples, a system for monitoring concept drift in a trained model is provided, the system comprising one or more processors configured to cause the system to: receive a first dataset representing model operations executed by the trained model; apply a data processing operation to the first dataset to determine a first result data based on the first dataset; determine, based on the first result data, a difference between the first result data and a second result data; determine, based on the difference, whether concept drift has occurred; and, in accordance with a determination that concept drift has occurred, transmit an instruction to update training of the trained model.

In some examples, a non-transitory computer readable storage medium storing one or more programs is provided, the one or more programs comprising instructions, which when executed by one or more processors of an electronic device, cause the electronic device to: receive a first dataset representing model operations executed by the trained model; apply a data processing operation to the first dataset to determine a first result data based on the first dataset; determine, based on the first result data, a difference between the first result data and a second result data; determine, based on the difference, whether concept drift has occurred; and in accordance with a determination that concept drift has occurred, transmit an instruction to update training of the trained model.

### BRIEF DESCRIPTION OF THE FIGURES

The patent or application file contains at least one drawing executed in color. Copies of this patent or patent application publication with color drawings will be provided by the Office upon request and payment of the necessary fee.

FIG. 1 illustrates an exemplary method for monitoring concept drift in a trained model, in accordance with some examples.

FIG. 2 illustrates an exemplary system for monitoring concept drift in a trained model, in accordance with some examples.

FIG. 3 illustrates an exemplary table providing the intent classification of user queries provided as textual data, in accordance with some examples.

FIGS. 4A-4D illustrate exemplary spatial distributions of various datasets including user queries received by a trained model over time, in accordance with some examples. FIG. 4A illustrates the spatial distribution of the user queries in an exemplary first dataset. FIG. 4B illustrates the spatial distribution of user queries in an exemplary second dataset. FIG. 4C illustrates the spatial distribution of user queries in an exemplary third dataset. FIG. 4D illustrates the spatial distribution of user queries in an exemplary fourth dataset.

FIG. 5 illustrates an exemplary spatial clustering analysis of a dataset, in accordance with some examples.

FIGS. 6A-6B illustrate exemplary word clouds generated from user queries corresponding to clusters in a spatial clustering analysis, in accordance with some examples.

FIG. 6A illustrates an exemplary word cloud generated from user queries corresponding to a first cluster. FIG. 6B illustrates a exemplary word cloud generated from user queries corresponding to a second cluster.

FIG. 7 illustrates an exemplary table showing an analysis of user queries included in a series of datasets, in accordance with some examples.

FIG. 8 illustrates an exemplary electronic device, in accordance with some examples.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of any of the systems and methods described herein combined in any suitable manner, including combinations of all or some of the aspects described.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

The following description is presented to enable a person of ordinary skill in the art to make and use the various embodiments. Descriptions of specific devices, methods, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown but are accorded the scope consistent with the claims.

Disclosed herein are exemplary systems, methods, and non-transitory storage media for monitoring trained models, such as chatbots, to detect concept drift and concept evolution relating to the way the trained model classifies user inputs to the model. Chatbots typically operate by accepting inputs from users, such as natural language user input data formatted as queries or questions, and predicting an output that best approximates the answer desired by the user. To determine an appropriate model output, chatbots may associate the user query with an intent classification that indicates to the chatbot the nature of the query and the desired response of the user. In determining the intent classification of a user query, a chatbot may convert user inputs into multi-dimensional vectors that contain data representative of various aspects of the user input, such as the content of the user query (e.g., the meaning of a natural language user input as determined by a natural language processing module of the chatbot), the context of the user query determined from the conversion with the user, and other information about the user and/or user input. This vectorized data is used by the model to determine an intent classification of a user query based on the information contained in the vectorized representation of the user query. For instance, the trained model may apply one or more statistical analyses to compare the user query with known intent classifications associated with the training data used to train the model. The model then outputs a response to the user, in some cases also a natural language output, that best approximates the output desired by the user based on the determined intent classification of the user input.

Training of chatbots typically occurs by inputting a series of labeled inputs into the chatbot during a training phase, where the labels are indicative of a known intent classification of each user query in the dataset. For instance, the chatbot may be trained on labeled historical user queries or conversations, where the intent classification of the user is previously known and can be used to teach the model to associate the information in that conversation or query (e.g., key words, phrases, and other information) with a given intent classification. The series of labeled user queries or conversations may be referred to as a “training dataset”. As the chatbot is trained on a large number of labeled user queries and conversations in a training dataset, the chatbot will extract information from the user queries in the training dataset to observe trends in the user queries that are associated with certain intent classifications. The extracted information may be represented in vectorized representations of the user conversations or queries, and the vectorized representations may be used by the chatbot to define the various intent classifications. These trends will be used by the chatbot to associate new user inputs (e.g., user inputs received after training and deployment of the chatbot) with an appropriate intent classification in the labeled training dataset.

Over time, user queries to a chatbot may change in response to changes in the world, such as a current events, product releases, and changes in the preferences of the users of the chatbot. New and unexpected user inputs will be associated with the intent classification in the training dataset that provides a best approximation of the desired output to the user. However, in some cases, the intent classifications defined by the training dataset may be ill-suited to the new and unexpected queries input by users. If the chatbot is not updated regularly, the chatbot may provide incorrect or misleading outputs that fail to account for drift or evolution in the inputs entered by users. Unexpected user queries may be falsely or inappropriately classified into intent classifications that are poorly fit to the actual intent of the user, causing the chatbot to output responses that misunderstand the nature of the user query. In some cases, the intent classifications may need retraining to refine and redefine existing intent classifications known to the model. In some cases, new intent classifications are needed to appropriately classify the unexpected user queries and to allow the model to better predict the response desired by a user.

In some examples, various associations between user input data and the intent classifications can be visualized by spatially representing vectorized user input data in a multi-dimensional space, where each dimension in the multi-dimensional space is associated with a value included in the vectorized input data Like user inputs are converted to similar vectors that, when spatially visualized, will form clusters that are representative of the intent classification of the user input. The relative location of the vectorized user input data with respect to the intent classification clusters in the multi-dimensional space is indicative of the likely intent classification of a user input. Depending on how closely the user input data is located relative to a cluster, an administrator or developer of the model can visually determine whether the user input data is likely to be correctly categorized into the existing intent classifications. User input data located on the periphery of a cluster, or user input data that is located far from any cluster, may indicate that the data is unexpected or different from the training dataset and may be better classified by a new intent classification not present in the training dataset. Shifts in the clusters themselves may indicate that the intent classifications of chatbot are changing responsive to the new and unexpected user inputs. In some cases, changes in the intent classification clusters or poor fitting of new user input data into existing intent classification clusters can indicate that the performance of the chatbot is degrading and/or that the chatbot requires retraining.

Some chatbots may update their models in real-time responsive to the processing of user queries, causing drift and evolution in the existing intent classifications as new user queries are received by the chatbot. As mentioned above, the changing configuration of the intent classifications over time may cause the operations of the model to become imprecise and less accurate, resulting in degraded performance of the chatbot. However, many chatbots lack the ability to self-monitor for changes in the way that user inputs are process and classified into intent classifications, making it difficult for administrators and developers of chatbots to determine when the intent classifications have changed. Other chatbots may be incapable of self-updating and may therefore fail to accurately classify new and unexpected user queries. In these cases, it may be advantageous to provide a visualization of the changes in user queries over time and instructions for retraining the chatbot when changes in the user queries indicate that new or modified intent classifications are needed. Further, many chatbots may be incapable of updating and retraining their models in real-time without discontinuing operation of the chatbot.

Accordingly, there is a need for systems and methods for monitoring the drift and evolution in intent classifications of trained models, such as chatbots, so that administrators and developers of trained models can determine when retraining is needed and take action to prevent the degradation of the models. Described herein are systems and methods capable of improved monitoring and detection of changes in the way that trained models process and categorize user input data into intent classification. The systems and methods may be implemented in a drift detection system that receives data about the operation of a trained model, and then uses the data to determine the drift and evolution of the intent classifications associated with user inputs into the trained model over time. When concept drift or concept evolution is detected in the intent classification of user inputs by the trained model, a drift summary report can be transmitted, prompting an administrator or developer of the model with instructions to update or retrain the model to correct the detected concept drift and/or concept evolution.

Such a system may operate independently from the trained model and receive real-time data from the trained model via a shared memory and/or application programming interface (API) in communication with the trained model and the drift detection system. Accordingly, the system can analyze data associated with the operations of the trained model in real-time to detect drifting and evolving intent classifications of user inputs, allowing for earlier intervention when the model's performance is degrading. Advantageously, parallel analysis of concept evolution and drift allows administrators of a trained model to visualize and assess the performance of the trained model in real-time, without requiring any downtime or disruption in the operation of the model. This capability may be particularly valuable for administrators and developers of models who are tasked with updating and retraining models when user inputs into the model change. Further, the independent operation of the drift detection system and communication via a shared memory and API allows for the system's integration with a variety of trained models, without requiring tailoring and modification to ensure compatibility with any particular trained model or chatbot. Accordingly, such systems and methods may be valuable for their ease of use with a variety of trained models and chatbots that currently exist or will be developed.

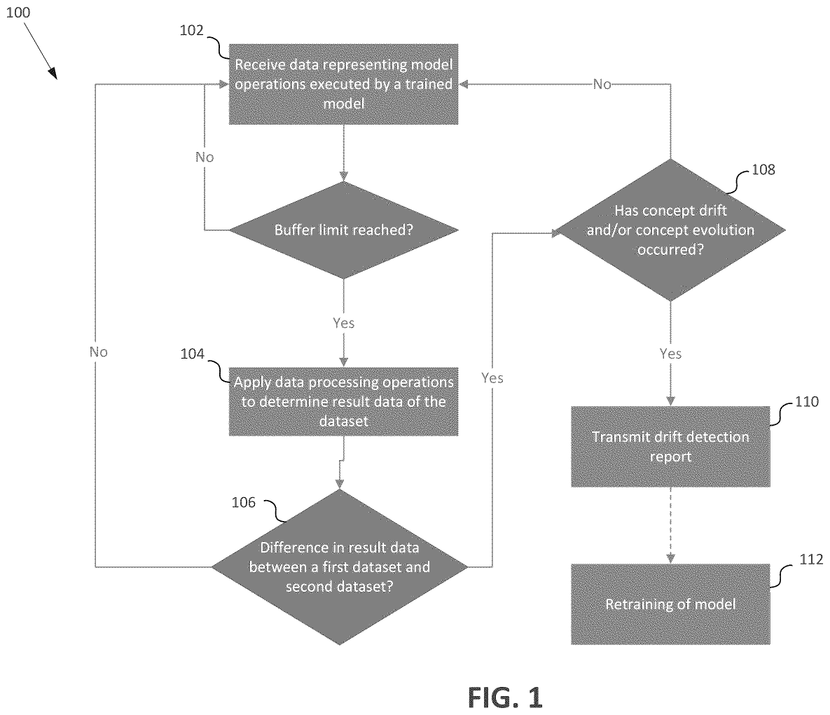

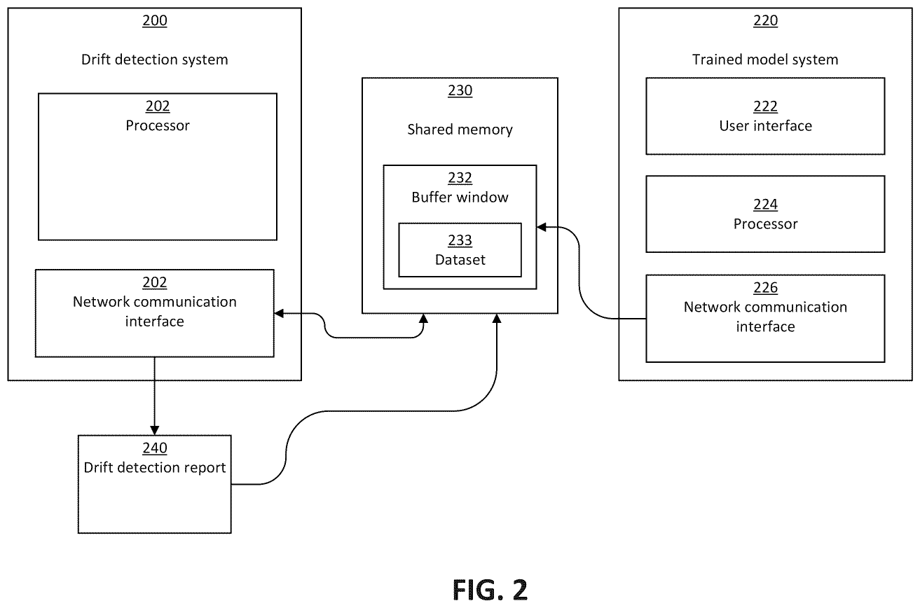

FIG. 1 illustrates an exemplary method 100 for monitoring concept drift in a trained model, in accordance with examples provided herein. Method 100 may be performed by a drift detection system in communication with a trained model, such as a chatbot. For instance, method 100 may be performed by the drift detection system 200 pictured in FIG. 2 and described below. In method 100, some blocks are, optionally, combined, the order of some blocks is, optionally, changed, and some blocks are, optionally, omitted. In some examples, additional steps may be performed in combination with the method 100. Accordingly, the operations as illustrated (and described in greater detail below) are exemplary by nature and, as such, should not be viewed as limiting.

In some examples, method 100 can begin at step 102, wherein step 102 comprises receiving a dataset representing model operations executed by a trained model. The dataset may include various data received by the trained model from a user of the model, such as user input data associated with one or more user queries or user conversations with the model. The dataset may also include various data generated by the trained model during model operations. For instance, the dataset may include model output data associated with one or more outputs from the trained model to the user of the model. Additionally or alternatively, the dataset may include or one or more pieces of data generated by the model responsive to user input data, such as vector data representative of the user input data, an intent classification of the user input data, or other data associated with the user input data. In some examples, the dataset further includes one or more labels applied by the trained model or by a user of the trained model, such as one or more labels associated with a particular intent classification of the data. In the example of a chatbot, a dataset may include data associated with a conversion between the user and the chatbot, such as user input data into the chatbot (e.g., natural language user queries into a chatbot), model output data from the chatbot (e.g., natural language outputs from a chatbot), and other data generated during use of the chatbot (e.g., contextual data about the conversation or the user, an intent classification associated with a user conversation, vectorized representations of the user input data and model output data, and other data).

In some examples, the dataset comprises textual data, such as a natural language data input into the model with the user's voice or on a user interface such as a keyboard or touchscreen. The textual data could include textual data associated with user input data into a trained model, such as one or more natural language user queries input into the trained model or textual data associated with a conversation a user has with the model. In some examples, the textual data includes data associated with one or more outputs of the trained model (e.g., one or more natural language outputs from the model responsive to a user query or conversation). The textual data may include a plurality of language entities (e.g., words, phrases, numbers, etc.). The textual data may comprise structured textual data (e.g., a sentence, a phrase, or a question) and/or unstructured textual data (e.g., one or more words, letters, numbers, or other unstructured textual input data received by the model). In some examples, a dataset further includes one or more image files, audio files, or other data associated with a user query or conversation.

As mentioned above, the data in a received dataset may include user input data input into the trained model, output data from the trained model, and/or a vector data representative of the user input data or model output data. In such examples, the trained model may be configured to determine, based on the user input data in the dataset, one or more vectors representative of each user input data. To create each vector, the trained model may extract information from the user input data representing various aspects of the user input data and store the aspects as tokens in the vectorized representation of the user input data. For instance, the model may extract information relating to the content of the user input data, a meaning of the user input data (e.g., the meaning of a natural language user query into a chatbot), the context of the user input data (e.g., information about the context of a conversation with a chatbot), and other information associated with the user input data. Such information may be represented quantitatively as values (alternatively referred to as tokens) in a multi-dimensional vector. Multi-dimensional vector may include a predefined number of fields for storing tokens associated with the user input data, with each token in the vector providing information about the association of the user input data with one or more intent classifications defined by the model. For instance, one token in the vector may indicate that the user input data is strongly associated with a first intent classification, while a second token in the vector may indicate a weaker association with the first intent classification (or may indicate an association with a second intent classification that is different from the first intent classification). The tokens in a vectorized representation of the user input data may then be analyzed collectively by the drift detection system (e.g., in a spatial clustering analysis or a statistical analysis) to associate each piece of user input data with one or more intent classifications of the trained model and to provide information about the trained model's classification of user inputs over time.

If the user input data of a dataset includes textual data (e.g., natural language user input data or model output data from a chatbot), then the trained model may extract various information about the textual data and convert the textual data to vector data similarly to the process described above. For instance, a user query “What is the name of the famous bridge in San Francisco?” input into a chatbot may be converted into a number of tokens in a vector representing different information about the query. The vector could include token indicating that the user is asking a question, that the question is about a famous bridge, that the question is about San Francisco, and that the user desires an output that is a name. In some examples, the tokens in a vector representation of textual data may represent various words or phrases in the query, such as a token representing each of the words of the query (e.g., “What,” “is,” “the,” “name,” and so forth) or tokens representing two or more words in the query that can be analyzed together to derive meaning from the textual data (e.g., “What is,” “the name,” “of the,” “famous bridge,” and “in San Francisco”). Such a vectorized representation of textual user input data may then be transmitted to a drift detection system and processed to determine various information about the data in a dataset.

In some examples, data from the trained model may be received and/or processed by the drift detection system in batches, referred to as datasets. As used herein, a dataset may represent an amount of data that can be analyzed collectively by the drift detection system to determine whether concept drift and/or concept evolution has occurred. In some examples, a dataset includes a predetermined amount of data, and receiving a dataset includes receiving the predetermined amount of data. The predetermined amount of data included in a dataset may be at least enough data to perform a statistical analysis, error rate analysis, or spatial clustering analysis of the dataset, such as any of the analyses described throughout the disclosure. In other examples, a dataset includes data received during a predetermined period of time of the model's operations (e.g., one hour, one day, one week, or one month), and receiving a dataset includes receiving data associated with the predetermined period of time. In some examples, the data in each dataset is associated with a timestamp, allowing the system to analyze temporal changes within a single dataset.

In some examples, the drift detection system receives datasets in an iterative process. The various datasets may be analyzed individually and comparatively by the drift detection system to identify differences in the data included within each dataset. For instance, the method may include receiving a first dataset, a second dataset, a third dataset, a fourth dataset, and/or a further dataset, each of the datasets comprising data representing model operations executed by the trained model. In some examples, the datasets represent various periods of time of the model's operations, such that a first dataset includes data processed by the model between times to and t₁, a second dataset includes data processed by the model between times t₁ and t₂, a third dataset includes data processed by the model between times t₂ and t₃, and so forth. In some examples, each dataset may include data that is distinct and non-overlapping, such that the data included in a first dataset is distinct or mutually exclusive of data included in a second or further dataset. In other examples, a first dataset and a second dataset may include overlapping or duplicative data (e.g., in datasets representing overlapping periods of time). In some examples, a dataset is defined by a shifting temporal buffer window, such that a first dataset includes data received between a first and second timepoint, and a second dataset may include data relating to a shifted first and second timepoint after the passage of time, which may overlap with the first dataset. In some examples, one or more of the datasets could be a training dataset used to train the model, or a dataset having a similar distribution to a training dataset that was used to train the trained model (e.g., a simulated dataset generated in accordance with various aspects of the training dataset, such as intent classifications or spatial distribution of the training dataset).

As data is received representing model operations executed by the trained model, the data may be stored in a shared memory accessible by the trained model and the drift detection system. In such examples, receiving a dataset representing model operations executed by the trained model may include receiving one or more datasets from the shared memory in communication with the drift detection system and the trained model. Data stored in the shared memory may include the user input data itself (e.g., raw natural language user queries input into a chatbot during a conversation with a user), vector data representative of the user input data, a predicted intent classification associated with the user input data, model output data (e.g., a natural language output from a trained model responsive to a user query), and/or other information about the model operations of the trained model.

The shared memory may include a buffer limit, which may be representative of the amount of data contained in a single dataset (and, in some cases, may represent a maximum amount of data storable in the buffer window of the shared memory at a particular point in time). As mentioned above, the buffer limit may be defined by a predetermined amount of data that is included in a dataset or by a predetermined period of time during which data is collected by the drift detection system. In some examples, the method may include storing data in the shared memory during a particular period of time, and then receiving a dataset from the shared memory when the period of time has elapsed. Additionally or alternatively, the method may include storing data in the shared memory until a threshold amount of data been stored in the shared memory, and then receiving a dataset from the buffer memory comprising the amount of data. Other data collection schemes are also envisioned. In some examples, and as shown in FIG. 1, the method includes determining, based on the data received by the shared memory, whether the buffer limit is reached. If the buffer limit is reached, the data may be transmitted from the shared memory into a drift detection system (e.g., for data processing operations, statistical analysis, spatial clustering analysis, and/or the determination of concept drift and concept evolution). In such examples, if the data received by the shared memory is less than the buffer limit, the shared memory may continue receiving data from the trained model until the buffer limit is reached.

In some examples, after receiving one or more datasets representing model operations executed by the trained model at step 102, the method 100 can proceed to step 104, wherein step 104 comprises applying a data processing operation to the one or more datasets to determine result data based on the dataset(s). The data processing operations performed by the drift detection system may include a statistical analysis operation of the dataset, a model error rate determination analysis of the dataset, a spatial clustering analysis of the dataset, and/or other data analyses performed to produce result data based on the dataset. The data processing operations may be used to compare the data in the dataset with a baseline dataset (e.g., a dataset comprising training data used to train the model, or a dataset that simulates the training dataset of the model), or to compare a first dataset with a second dataset generated during model operations of the trained model.

Applying a statistical analysis operation to a dataset could include analyzing one or more datasets to determine a statistical output (e.g., a statistical distribution) relating to the one or more datasets. Such data based methods may be used to evaluate a statistical difference between the one or more datasets. For instance, one or more datasets may be statistically analyzed to determine a statistical distribution of the data set(s), a maximum mean discrepancy of the dataset(s), a least-squares density difference of the dataset(s), a vector quantization of the dataset(s), a partitioning of the dataset(s) (e.g., partitioning of the dataset(s) into one or more clusters), a divergence of the dataset(s), or an uncertainty of the dataset(s). In some examples, applying the statistical analysis operation to the dataset(s) includes performing a Kolmogorov-Smirnov (KS) test, a maximum mean discrepancy (MMD) test, a least-squares density difference (LSDD) test, a KMeans and chi square, an equal intensity KMeans (EIKMeans) and chi square test, a Jensen-Shannon (JS) divergence test, and/or an uncertainty.

In other examples, a model error rate determination analysis is performed on one or more datasets to determine an error rate of the one or more datasets. The model error rate determination may determine, based on the one or more datasets and an intent classification of the datasets, a classification accuracy of the trained model. In such examples, the one or more datasets may include a predicted intent classification of the user input data in the dataset, which may be determined based on output data from the model, labeling of the user input data in the dataset, or some other data analysis described herein. The result data could include an error rate of the dataset, a probability of an error in one or more of the datasets or one or more data included in the datasets, a difference in the error rate of a first dataset and a second dataset, or a temporal change represented by the difference in the error rate of the one or more datasets. In some examples, the model error rate determination analysis includes a Fisher's test and/or a statistical test of equal proportions (STEPD).

In some examples, the data processing operations include performing a spatial clustering analysis to visualize the relationship between the user input data and intent classifications in a training dataset used to train the model. In the spatial clustering analysis, the drift detection system may analyze various information about the dataset, such as the predicted intent classifications of data in the dataset, the likely intent classification of the data in the dataset determined by the trained model, and whether the data in the dataset is likely to fit within the predefined user intent classifications of the trained model. The spatial clustering analysis generated by the drift detection system may be used to evaluate datasets from the trained model and/or to predict whether a particular dataset or group of datasets is likely to cause concept drift or concept evolution in the trained model and to determine when model retraining is needed.

To perform a spatial clustering analysis, the drift detection system may determine a spatial location of each of the data in a dataset in a multi-dimensional space, where the location of the user input data in the multi-dimensional space is indicative of an intent classification of the user input data. In some examples, applying the spatial clustering analysis to the dataset may include spatially representing the vectorized data representative of user input data in the dataset in a multi-dimensional space. Each of the vector data may be spatially located in the multi-dimensional space based on the value of tokens within the vector, each token representing a position in a dimension of the multi-dimensional space. Accordingly, the spatial distribution of the dataset in the multi-dimensional space may provide information about the relative similarity of the user input data in the dataset and/or a predicted intent classification of the user input data in the dataset.

In a spatial clustering analysis, user input data relating to similar topics may produce similar vectors that, when spatially located in the multi-dimensional space, form clusters representing an intent classifications associated with the data. For instance, user input data relating to San Francisco may be clustered together in the multi-dimensional space, and user input data about bridges in San Francisco may be clustered at an even closer distance in the multi-dimensional space, while user input data relating to New York city may be positioned in a different cluster in the multi-dimensional space. Accordingly, the spatial distribution of the dataset may provide an indication to the drift detection system of the likely intent classifications associated with the dataset. The drift detection system may then use the clustering of the user input data to predict an intent classification that the trained model would apply to the user input data in the dataset.

In some examples, performing a spatial clustering analysis on the dataset may include determining various characteristics of one or more clusters in the multi-dimensional space formed by the dataset, such as the spatial location of a cluster, the number of clusters, the size of a cluster, the density or compactness of a cluster, the shape of a cluster, the relative location of one or more clusters, the entropy distribution of one or more of the clusters, or some other characteristic of the clusters. In some examples, the spatial clustering analysis is configured to determine an intracluster distance (e.g., the distance between two or more of the clusters or centerpoints of the clusters) and/or an intercluster distance (e.g., a distance between one or more datapoints included in one of the clusters). Additionally or alternatively, the spatial clustering analysis may determine a ratio between an intercluster distance and an intracluster distance. The ratio may provide an indication of a K value representing a difference between one or more of the clusters, which may be monitored over time to provide information about the relative temporal changes in the clusters. Various aspects of the spatial clustering of the data in a dataset may be determined based on algorithms such as KMeans and HBDSCAN.

In some examples, the data processing operation is configured for determining one or more intent classifications associated with the user input data. For instance, a statistical analysis operation performed on the dataset may compare various statistical outputs associated with the data in the dataset with a number of known intent classifications of a training dataset (e.g., by determining a spatial distribution of the datasets). Similarly, a spatial clustering analysis may be configured to determine a spatial location of one or more of the vectorized user input data in the first dataset with respect to one or more of the clusters. The spatial cluster analysis may approximate a spatial location of one or more clusters in the multi-dimensional space by identifying the centerpoint of the one or more clusters and then may determine a difference between the location of a cluster and a location of one or more of the vectorized user input data in the dataset. The difference in location between the vectorized user input data in a dataset and the location of one or more of the clusters may provide information to the drift detection system regarding the predicted intent classification of the user input data or the relative accuracy or confidence level of the intent classification of the user input data. For instance, user input data in a dataset that is located close to the centerpoint of a cluster may be associated with the intent classification associated with that cluster with high confidence. Data in the periphery of the cluster may be associated with the intent classification at a lower confidence. User input data that is not close to any cluster may be noted by the drift detection system and included in instructions for relabeling the user input data, if necessary, with a new intent classification that is different from the intent classifications represented by the existing clusters and then updating the trained model. In some examples, a predicted intent classification of data in the dataset may be determined in a binary manner (e.g., “this data [is/is not] associated with intent classification A”). In other examples, the intent classification of the data may be determined based on a probability that the data belongs in a particular intent classification associated with one or more of the clusters (e.g., there is a 70% chance that the data is associated with intent classification A, and a 30% change that the data is associated with intent classification B″).

As additional datasets are received by the drift detection system, such as a second dataset and a third dataset, additional data processing operations can be performed on the datasets to determine various result data relating to the additional datasets (e.g., statistical outputs, error rates, or spatial clustering results). The result data of further datasets may be similar to the result data of the first dataset, for instance, if a second dataset includes similar user input data as the first dataset (e.g., if user input data likely to be categorized into similar intent classifications as the first dataset or shares other traits with the first dataset). If the user input data in the second dataset is different from the user input data in the first dataset, then the result data of a second or further dataset may be different from the result data of the first dataset. For instance, the spatial clustering analysis of a second dataset may produce clusters that have a different spatial location, number, size, density or compactness, shape, relative location, entropy distribution, or some other characteristic compared with the clusters produced by the spatial clustering analysis of the first dataset.

As data processing operations are applied to the vectorized user input data from successive datasets, the drift detection system may determine difference in the user input data processed by the trained model. For instance, increases in the maximum mean discrepancy, least-squares density, data partitioning, divergence, uncertainty, or error rate could indicate that the successive datasets may be less accurately classified by the model and that retraining of the model is needed. Further, changes in the spatial location, number, size, density or compactness, shape, relative location, or entropy distribution of clusters in a spatial clustering analysis as successive datasets are received and analyzed by the drift detection system may indicate that the intent classifications of the trained model may be less likely to correctly associate the user input data in successive datasets with a correct intent classification. The drift detection system may be configured to determine whether one or more of the clusters is changing shape, increasing or decreasing in compactness, diverging from another cluster, converging with another cluster, whether a new cluster is emerging, or some other aspect about the shape, location, or spatial distribution of the clusters in the multi-dimensional space. The determination and/or quantification of the difference between the result data of a first dataset and a second dataset may provide an indication of temporal changes in the processing of data received by the trained model.

Accordingly, in some examples, after applying a data processing operation to the first dataset to determine a first result data of the first dataset at step 104, the method can proceed to step 106, wherein step 106 comprises determining, based on the result data, a difference between the first result data and a second result data. The second result data may relate to a second dataset and be determined by applying the same data processing operation to the second dataset as was applied to the first dataset at step 104, thereby enabling the drift detection system to determine differences between the first and second datasets, such as temporal changes in the datasets.

As mentioned above, the user input data processed by a trained model may vary over time as user preferences changes, current event occur, and other changed affect user inputs into the trained model. Accordingly, the result data of a first dataset may be different from the result data of a second dataset. The result data may include a statistical output determined by a statistical analysis operation, an error rate determined by an error rate determination analysis, or some other result data determined by the drift detection system. In a spatial clustering analysis, the result data may include a spatial distribution of the dataset or one or more clusters formed by the datasets. The drift detection system may compare the result data of a first dataset with the result data of a second dataset to identify differences between the result data of the first dataset and the result data of the second dataset that may be indicative of concept drift or concept evolution. In some examples, the difference in the result data is indicative of a temporal change in the datasets over time associated with the model operations executed by the trained model.

As mentioned above, in some examples, determining a difference between a first dataset and a second dataset includes determining a difference in the statistical output produced in a statistical analysis operation conducted on the datasets. For instance, the difference could be a difference in a statistical distribution of the dataset(s), a maximum mean discrepancy of the dataset(s), a least-squares density difference of the dataset(s), a vector quantization of the dataset(s), a partitioning of the dataset(s) (e.g., partitioning of the dataset(s) into one or more clusters), a divergence of the dataset(s), or an uncertainty of the dataset(s). The difference in the statistical output could indicate that the user input data input into the trained model is different between the first dataset and the second dataset, which may be indicative of a temporal change in the user input data received and processed by the trained model that may prompt retraining or updating of the model.

In other examples, determining a difference between the first and second datasets could include determining a difference in the error rate of the datasets. The difference in error rate could be a difference in the error rate of a first and second dataset, a difference in the probability of an error in classifying one or more data included in the datasets with an intent classification, or some other error rate data determined by a model error rate determination analysis of the datasets. The difference in error rate between the first and second datasets could indicate that the classification of user input data by the model is becoming more or less accurate, which may be indicative of concept drift in the trained model's classification of user inputs. The difference in error rate between the first and second datasets may also indicate that the user input data input into the trained model is different between the first and second datasets, which may be indicative of a temporal change in the user input data received and processed by the trained model that may prompt retraining or updating of the model.

In a spatial clustering analysis, determining a difference between a first dataset and a second dataset may include determining a difference in the spatial location, number, size, density or compactness, shape, relative location, entropy distribution, or some other characteristic of the clusters formed by the first dataset and the clusters formed by the second dataset. For instance, the method could include determining, based on the spatial distribution of a first dataset, a characteristic (e.g., any of the characteristics listed above) of a first cluster of the first dataset. The method may additionally include determining, based on the spatial distribution of the second dataset, a second characteristic of a second cluster of the second dataset. In such examples, the difference may include a difference between the first characteristic of the first cluster and a second characteristic of the second cluster. In some examples (e.g., when analyzing changes to a cluster associated with an intent classification), the first cluster may correspond to the second cluster (i.e., may pertain to the same intent classification).

In some examples (e.g., when analyzing whether a new intent classification is needed with respect to the first or second datasets in the case of concept evolution), the difference could include a difference between a first determined number of clusters in the first dataset and a second determined number of clusters in the second dataset. In such examples, the method could include determining, based on a spatial distribution of the first dataset, a number of clusters in the first dataset. The method may additionally include determining, based on a spatial distribution of the second dataset, a number of clusters in the second dataset. A difference in the number of clusters in the first and second dataset may indicate that a new intent classification is needed for the trained model to appropriately categorize the data in the first dataset and the second dataset into intent classifications (e.g., in the case of concept evolution).

In some examples, the second dataset is a training dataset used to train the model, such that the difference is representative of a temporal change in the user input data or model processing operations between the initial training of the model and a time period associated with the first dataset received by the drift detection system. Additionally, or alternatively, the second dataset may comprise user input data processed by the trained model during a different period of time than the first dataset. For instance, the second dataset may be an inference dataset processed by the trained model at a different time than the first dataset. Accordingly, the difference between the first result data and the second result data may represent a temporal change in user input data or model processing operations occurring between the period of time that the first dataset was processed by the trained model and the period of time that the second dataset was processed by the trained model. In some examples, the drift detection system may monitor the temporal changes to various clusters in a spatial distribution of datasets produced via a spatial clustering analysis of additional datasets processed by the trained model.

Returning to the method 100 depicted in FIG. 1, after determining, based on the first result data of the first dataset and/or a second result data of a second dataset, a difference between the first result data and the second result data, the method may proceed to step 108, wherein step 108 comprises determining, based on the difference, whether concept drift has occurred. In some examples, step 108 of the method further comprising determining, based on the difference, whether concept evolution has occurred.

As used herein, “concept drift” refers to the phenomenon in which the classification of user inputs by a trained model changes over time responsive to changes in the user input data (e.g., user queries) processed by the trained model. For instance, a chatbot for a travel company may receive various questions from tourists traveling to San Francisco, such as user queries about famous tourist destinations, sightseeing opportunities, and activities in the greater San Francisco Area. The chatbot may be trained with a labeled dataset that allows the chatbot to associate user queries with specific intent classifications, such as “Golden Gate Bridge”, “Chinatown”, “Napa Valley”, and “Golden Gate Park”. Responsive to budget concerns, the city of San Francisco may adopt a new policy that causes the cost of tolls on the Golden Gate Bridge to increase, resulting in increased user queries about toll costs for traveling to San Francisco over the Golden Gate Bridge. Accordingly, the existing intent classification associated with the Golden Gate Bridge (which may be trained on user queries such as “Where is the best viewing point for seeing the Golden Gate Bridge?”, “Is the Golden Gate Bridge open to pedestrians?”, and other common tourism-related questions) may drift to include questions about the tolls paid by cars traveling over the bridge. Over time, the increase in user queries about the tolls may cause changes in the way that the model categorizes user queries such that the model begins to associate questions about the toll costs into the Golden Gate Bridge intent classification. Accordingly, the Golden Gate Bridge intent classification of the trained model may expand (or “drift”) to include additional user queries not originally anticipated in the training dataset of the model.

“Concept evolution” is a subset of concept drift that occurs when an entirely new intent classification is needed to accommodate user input data relating to a new topic not included in a training dataset. As used herein “concept evolution” refers to the phenomenon wherein changing user input data processed by a trained model over time prompts the need for additional intent classifications for categorizing the user input data. For instance, the city of San Francisco may decide to construct a new bridge connecting the city to a different part of Oakland, prompting an increase in user queries to the chatbot about the newly-constructed bridge. The training dataset for the chatbot will not have included any user input data labeled with an intent classification relating to the new bridge. Initially, the chatbot may have difficulty categorizing queries about the newly constructed bridge, and may loosely associate the queries with the Golden Gate Bridge intent classification, causing the chatbot to output incorrect or misleading information to travelers using the chatbot. As the chatbot continues to receive additional queries about the newly constructed bridge, the user queries about the bridge may diverge from the user queries about the Golden Gate Bridge, as the queries will include additional or different information that is clearly not relevant to the existing Golden Gate Bridge intent classification. Eventually, the model may be retrained to accommodate a new intent classification associated with the new bridge (e.g., by manually retraining or updating the model with new labeled user input data associated with the bridge, or by an automatic retraining system of the model).

Returning to step 108 of the method 100, determining whether concept drift has occurred may include determining that the difference between the first result data and the second result data indicates that user input data of the datasets are different and/or that one or more of the datasets is causing changes in the intent classification of the trained model. For instance, a difference in the statistical output of the first dataset and the second dataset could indicate that the user input data input into the trained model is changing over time. In some examples, determining whether concept drift has occurred includes determining that the statistical output of the first dataset has a greater (e.g., wider) statistical distribution than the statistical output of the second dataset (or vice versa). In various examples, determining whether concept drift has occurred includes determining that a maximum mean discrepancy, a least-squares density, a vector quantization, a partitioning (e.g., partitioning of the dataset(s) into one or more clusters), a divergence, or an uncertainty of the first dataset is greater than the same statistical output of the second dataset (or vice versa).

A difference in the error rate of the first dataset and the second dataset could similarly indicate that the user input data input into the trained model is changing over time. Additionally, a difference in the error rate could indicate that the model's classification of user input data into the intent classifications is more or less accurate in the first dataset compared to the second dataset. In some examples, determining whether concept drift has occurred includes determining that the error rate of the first dataset is greater than the error rate of the second dataset (or vice versa).

A difference in the spatial distribution of a first and second dataset as determined by a spatial clustering analysis may indicate that a characteristic of one or more clusters associated with an intent classification is changing over time. The difference in spatial distribution may be indicative of a change in user input data received by the model between the first and second datasets. Determining whether concept drift has occurred could include determining, based on the difference between the first and second datasets, that the spatial location, number, size, density or compactness, shape, relative location, entropy distribution, or some other characteristic of a cluster associated with a particular intent classification has changed. In some examples, determining whether concept drift has occurred includes determining that one or more of the clusters is converging or diverging from another cluster.

For instance, in some examples, determining whether concept drift has occurred may include determining that a cluster of the first dataset is in a different location than a second cluster comprising the second dataset. In some examples, determining whether concept drift has occurred includes determining that the size or shape of a first cluster of the first dataset is different than the size or shape of a second cluster of the second dataset. In yet further examples, determining whether concept drift has occurred includes determining that a first cluster of the first dataset has an increased or decreased density compared to a second cluster of the second dataset. In some examples, determining whether concept drift has occurred includes analyzing multiple characteristics of the clusters in parallel, such as the location, shape, and/or density of a first cluster of the first dataset relative to a second cluster of the second dataset.

In some examples, determining whether concept drift has occurred comprises determining whether the difference in result data is greater than a threshold value. For instance, a threshold value may be chosen representing a maximum allowable difference between a statistical output, an error rate, or a spatial distribution in a first dataset compared to a statistical output, error rate, or spatial distribution of a second dataset. In such examples, if the difference exceeds the threshold value, the drift detection system may determine that concept drift has occurred. In a statistical analysis operation, the threshold value may be a threshold maximum mean discrepancy, a threshold KMeans or chi square value, a threshold equal intensity KMeans or chi square value, a threshold divergence, or a threshold uncertainty difference between the datasets. In a model error rate determination analysis, the threshold value may be a threshold error rate difference between the datasets. In a spatial clustering analysis, the threshold value may be a threshold value relating to any of the characteristics of the clusters identified above, such as the size of a cluster, the density or compactness of a cluster, the shape of a cluster, the relative location of one or more clusters, the entropy distribution of one or more of the clusters.

Determining whether concept evolution has occurred may include determining that the difference in the result data indicates that a new intent classification is needed to accurately classify data in the first dataset and/or second dataset. For instance, a difference in the statistical outputs or error rates of the first and second datasets could indicate that concept evolution has occurred and a new intent classification is needed. Temporal changes in the spatial distribution of the first and second dataset as determined in a spatial clustering analysis may also indicate that additional clusters have formed, the additional clusters relating to a new intent classification not existing in the training data of the trained model. For instance, determining whether concept evolution has occurred could include, based on the a difference in result data from a first and second dataset, that the number of clusters of a first dataset is different from a number of clusters in a second dataset. In such examples, the difference may comprise a difference between a first determined number of clusters of the first dataset and a second determined number of clusters in the second dataset. In some examples, the identification of clusters associated with a new intent classification may be done manually, e.g., by an administrator or developer of a trained model based on the spatial clustering analysis. In some examples, the identification of the new intent classification may be made based on a word cloud generated for each cluster of the first and second datasets.

Additionally or alternatively, the identification of clusters associated with a new intent classification may be done automatically by running statistical tests to determine divergent distributions in the datasets when compared to the distribution of a training dataset or another dataset associated with the trained model processing operations. For instance, determining whether concept evolution has occurred could include determining, based on a statistical output relating to the first and second datasets, that a new intent classification is necessary for classifying the user input data in the first and/or second datasets. Determining whether concept evolution has occurred could also include determining, based on an error rate of the first and second datasets, that a new intent classification is necessary for classifying the user input data in the first and/or second datasets.

In some examples, determining whether concept drift and/or concept evolution has occurred includes determining that the difference in the spatial distribution of one or more of the clusters is greater than a threshold value. For instance, the threshold value could be indicative of a distance between one or more of the clusters, such that concept drift is determined when a first cluster comprising the first dataset is greater than a specified distance from a second cluster comprising the second dataset. In another example, the threshold value could be indicative of a density of one or more of the clusters, such that concept drift is determined when the density of a first cluster comprising the first dataset is greater or lesser than the density of a second cluster comprising the second dataset. In a further example, the threshold value could be indicative of the formation of a new cluster, such that concept evolution is determined when the number of clusters of the first dataset is different from the number of clusters is the second dataset.

In some examples, the drift detection system may apply a statistical test to the first dataset and the second dataset to determine whether concept drift and/or concept evolution has occurred. For instance, the statistical test may determine, based on a difference (e.g., a temporal change) between a first dataset and a second dataset, whether the temporal change is likely indicative of concept drift and/or concept evolution. In some examples, and as mentioned above, the statistical test may determine whether the temporal change is greater than a threshold value. In various examples, the statistical test could be a data distribution-based method, such as:
Kolmogorov-Smirnov (KS) test, which is a nonparametric test of the equality of continuous, one-dimensional probability distributions that can be used to compare a sample with a reference probability distribution;
Maximum Mean Discrepancy (MMD) test, which measures distance in the space of embedding of probabilities in a reproducing kernel Hilbert space;
Least-Squares Density Difference (LSDD) test, which is a single-shot procedure for directly estimating the density difference without separately estimating two densities;
KMeans and Chi Square Test—test is used to determine whether there is a statistically significant difference between the expected frequencies and the observed; or Equal Intensity KMeans (EIKMeans) and Chi Square Test.

In some examples, the statistical test is a drift magnitude-based method, such as determining relative drift using a Jensen-Shannon (JS) Divergence test. Additionally or alternatively, the statistical test may be an uncertainty based statistical test, such as uncertainty classifier. In some examples, the statistical test includes an error rate-based method, such as:
Fisher's Test, which is a statistical significance test used in the analysis of contingency tables; or
Statistical Test of Equal Proportions (STEPD), which is a simple, efficient, and well-known method which detects concept drifts based on a hypothesis test between two proportions.

Returning to the method depicted in FIG. 1, after determining, based on the difference, whether concept drift and/or concept evolution has occurred at step 108, the method 100 may proceed to step 110, wherein step 110 includes, in accordance with a determination that concept drift and/or concept evolution has occurred, transmitting an instruction to update training of the trained model. In some examples, the instruction is included in a drift summary report that provides information to an administrator or developer of the trained model about the existence, character, or magnitude of the concept drift and/or concept evolution detected by the drift detection system. For instance, the instruction could include an identification of intent classifications associated with the datasets that have experienced concept drift or concept evolution, the extent of the concept drift as represented by the differences in result data associated with the datasets, and/or the extent of concept evolution as represented by the formation of new clusters comprising data from the datasets.

In some examples, the instructions may be presented on a dashboard on a user interface, such as a user interface associated with the trained model or a user interface used for training and updating of the trained model. In some examples, the instructions may be transmitted to an electronic device, such as the electronic device of an administrator or developer of the model and/or presented on a user interface of the electronic device. In some examples, the instructions are transmitted to a server or to a cloud computing system, e.g., for storage, further processing, or data analysis. Additionally or alternatively, the instructions may be transmitted to a shared memory for storage of the instructions or later transmission of the instructions from the stored memory to a trained model in communication with the shared memory.

As specified above, in some examples the instructions are provided contingent on a determination that concept drift or concept evolution has occurred. However, in other examples, the instructions may be transmitted for each dataset received and analyzed by a drift detection system according to the method 100. Accordingly, the instructions may be transmitted irrespective of whether concept drift or concept evolution has been detected with respect to one or more of the datasets. For instance, the instructions may include a generalized overview detailing various information about the datasets, such as the statistical outputs, error rates, and spatial distributions of the datasets and the characteristics of the datasets irrespective of whether concept drift or concept evolution has occurred.

If concept drift is present, the instructions may include information about the character and extent of the concept drift. For instance, the instructions may include information about the difference in maximum mean discrepancy of the dataset(s), a least-squares density difference of the dataset(s), a vector quantization of the dataset(s), a partitioning of the dataset(s) (e.g., partitioning of the dataset(s) into one or more clusters), a divergence of the dataset(s), or an uncertainty of the dataset(s). In some examples, the instructions include information about the difference in error rate of the datasets. The instruction may also include information about the difference in spatial location, number, size, density or compactness, shape, relative location, entropy distribution, or some other characteristic of the clusters of the first dataset and the second dataset.

In some examples, the instructions may include information about particular user input data in the datasets associated with the concept drift. For instance, if the concept drift has resulted in an increased error rate in a dataset, the instructions could include an identification or one or more data responsible for the increase in error rate. If the concept drift has resulted in the change of a cluster's shape in a spatial clustering analysis, the instructions could include an identification of one or more user input data in the datasets that has caused the changed in the shape of the cluster. In another example, if the concept drift has resulted in a change in the density or compactness of a cluster or a change in the statistical distribution of the data, the instructions could include an identification of one or more user input data in the datasets that is farthest from the centerpoint of the cluster or farthest from the mean of the statistical distribution. In some examples, the instructions may prompt the administrator or developer of the trained model to retrain or update the model with the identified user input data to further improve the intent classification of the trained model.

If concept evolution is present, the instructions may include information about the character and extent of the concept evolution. For instance, the instructions may include information about the number of new intent classifications detected (which may be represented by clusters in a spatial clustering analysis or a spatial distribution in a statistical analysis) in the first or second dataset. The instruction may also include information about the characteristics of the new clusters (e.g., the spatial location the cluster(s), the density or compactness of the cluster(s), the shape of a cluster(s), the relative location of the cluster(s), the entropy distribution of the cluster(s) or some other characteristic of the new clusters and/or their relationship with existing clusters in the datasets. In some examples, the instructions may include information about particular user input data in the datasets associated with the concept evolution. For instance, if the concept evolution has resulted in the formation of a new intent classification, the instructions could include an identification of one or more user input data in the datasets that is associated with the new intent classification. The user input data associated with the new intent classification may be presented to an administrator or developer of the model (e.g., so that the administrator or developer can proceed to analyze or label the user input data with an intent classification and then retrain the model). In some examples, the instructions may prompt the administrator or developer to retrain or update the model with the identified user input data associated with the new intent classification to retrain or update the trained model to accommodate the new intent classification.

Returning to FIG. 1, after transmitting an instruction to update training of the trained model at step 110, the method 100 may proceed to step 112, wherein step 112 includes retraining the trained model. In some examples, the model may be retrained by an administrator or developer of the model according to the transmitted instructions. Advantageously, this may allow the administrator or developer control and oversight over the retraining of the model and the addition or modification of the intent classifications of the model. Additionally or alternatively, the trained model may be configured to update automatically after receiving the transmitted instructions from the drift detection system (e.g., by accessing the instructions in a shared memory after the instructions have been transmitted to the shared memory by the drift detection system). For instance, transmitting the instruction to update training of the trained model may include transmitting executable program code configured to cause the trained model to be retrained when the code is executed by one or more processors. Retraining of the trained model may, in some cases, proceed without downtime or disruption in the model operations executed by the trained model.

In some examples, retraining the model includes applying one or more labels to the data in one or more of the datasets analyzed by the drift detection system according to the method 100. The labels provided to the data may be associated with an intent classification of the data that more accurately identifies a correct or ideal intent classification of the data in the datasets. In some examples, e.g., when concept evolution is detected, the intent classifications associated with the labeled data may be different from the existing intent classifications included in a training dataset of the model. In other examples, e.g., when concept drift is detected, the intent classifications associated with the labeled data may be the same as the existing intent classifications included in a training dataset. In some examples, the data is labeled manually by an administrator or developer of the model, for instance, by reviewing the transmitted instructions from the drift detection system and determining, based on an analysis of the data included in the instructions, a correct intent classification of the data. Additionally or alternatively the data may be labeled automatically by the drift detection system. For instance, the drift detection system may predict a correct intent classification associated with the data based on the statistical data operations, an error rate analysis, or a spatial clustering analysis of the datasets.

Retraining the trained model may further include updating the trained model based at least in part on the labeled dataset(s). For instance, retraining the model may include inputting the labeled dataset into the model and processing the labeled dataset with the model to update one or more training files (e.g., a weight file) of the model. In some examples, the retraining of the model causes a drift detection application programming interface (API) of the model to update to accommodate the data received in the retraining. For instance, the training files and the API may be updated to incorporate a new intent classification based on detected concept evolution or to reconfigure existing intent classifications based on detected concept drift. Optionally, the model may be retrained by updating the model based on the labeled first dataset and/or any additional labeled datasets processed by the drift detection system, such that the retrained model reflects the intent classifications identified in only the datasets analyzed by the drift detection system. In other examples, the model may be retrained by updating the model based on the labeled datasets as well as a training dataset or a simulated training dataset of the model, such that the retrained model reflects both the original intent classifications in the training dataset as well as any intent classifications identified by the drift detection system according to the method 100. In some examples, and to improve the robustness of retraining, data from the datasets that are associated with the concept drift and/or concept evolution may be given proportionately more weights as compared to other data while re-training the model.

FIG. 2 illustrates an exemplary drift detection system 200 for monitoring concept drift in a trained model. The drift detection system 200 may comprise one or more processors 202 (referred to hereinafter as processors 202) configured to execute one or more programs or applications, such as a program or application stored in a software and readable by a processor 202, to perform drift detection techniques as described herein. The processor 202 of the drift detection system 200 is configured to execute instructions to cause the system to monitor concept drift in a trained model, such as a trained model executed by trained model system 220. The trained model may, for example, be a chatbot. The instructions executed by processor 202 may be configured to cause drift detection system 200 to perform various steps of a drift detection method, such as the steps of method 100 illustrated in FIG. 1 and described above. The processor 202 may be located on a common computing device, a server located remotely from system 220, and/or on a cloud computing network in communication with one or more components illustrated in FIG. 2. Drift detection system 200 may be configured to operate separately from trained model system 220 and may be implemented on a separate computing device, server, cloud, or the like from trained model system 220. In other examples, drift detection system 200 be executed by a same device, server, cloud, or the like as trained model system 220. In some examples, one or more drift detection algorithms executable by system 200 is included in a pip-installable toolkit which may be integrated with a variety of different trained models executable by system 220.

The drift detection system 200 additionally includes a network communication interface 202 configured to communicate with one or more other components illustrated in FIG. 2, such as a shared memory 230, trained model system 220, and/or external devices such as external computing devices, remote servers, and cloud computing systems. For instance, the network communication interface 202 may be configured to receive data from the trained model system 220 (e.g., data relating to datasets processed by the trained model), optionally via a shared memory 230, and further to transmit data from the drift detection system 200 (e.g., transmitting a drift detection report 240 including retraining instructions for the model system). The drift detection report 240 may be transmitted and stored on the shared memory 230, transmitted to the trained model system 220 or transmitted to an external devices or system where the report or instructions are accessible by an administrator or developer of a trained model. The network communication interface 202 may communicate via any suitable wired and/or wireless communication protocol (including via bus communications for implementations in which the systems are provided as parts of the same computer device). In some examples, network communication interface 202 may communicate via one or more application programming interfaces (APIs). The one or more APIs may facilitate the exchange of information between the drift detection system 200, the shared memory 230, and/or the trained model 220, allowing the drift detection system 200 to transmit and receive data from the shared memory 230 and trained model 220 in a format that is readable and processable by the system components described herein. For example, an API may facilitate the exchange of data (e.g., to be stored in shared memory 230) at particular time intervals, such that datasets 233 may be sent to (or retrieved from) buffer window 232 of shared memory 230 according to said intervals. An API may advantageously enable to drift detection system 200 to communication with a variety of different trained models without requiring modification of the detection system 200 for each different trained model.

The trained model system 220 includes a user interface 220, a processor 224, and a network communication interface 226, and is in communication with the drift detection system 200 and/or shared memory 230. The trained model system 220 may implement a program or application via processor 224 to receive user input, to execute a trained model, provide model output data, and/or to provide data regarding said user input and/or said trained model execution to shared memory 230. For example, system 220 may receive user input data via the user interface 222, process the user input data at the processor 224, and output model output data responsive to receiving the user input data (e.g., model outputs readable by a user of the trained model, and/or one or more data outputs, such as a vectorized representation of user input data or an intent classification or the user input data). In some examples, trained model system 220 executes a chatbot configured to facilitate natural language conversations with users and to provide natural language model output data responsive to natural language user input data (e.g., user queries into the chatbot). The processor 224 of the trained model system 220 may be included in an electronic device, a remote server, a cloud, or some other computing system.

The trained model system 220 is configured to accept training files, model files, scripts, and pipeline configuration files (e.g., yml files) executable by the processor 224 to configure the operations of the model. For instance, the trained model 220 may include various files and scripts that are executable by the processor 224 to run a chatbot application and to train the chatbot. These may include model training files, model maintenance scripts (e.g., files for serving, re-training, or updating the model), and other configuration files (e.g., credentials, domains, or endpoints). In some trained model systems, such as model systems configured to interface with a drift detection system 200, additional files may be included, such as custom scripts and/or configuration files configured to store data from the trained model, periodically provide information to shared memory 230, and/or periodically interrogate (or otherwise receive information from) a drift detection system. The trained model system 220 may be configured to communicate with a shared memory 230 and the drift detection system 200, as well as other external programs and devices, via a network communication interface 226. Optionally, network communication interface 226 may communicate via one or more APIs.

The user interface 222 of the trained model system 220 is configured to accept user input data from users of the model, such as user queries from users of a chatbot. The user input data may include textual input data, natural language data (e.g., textual or spoken natural language data), image data, audio data, one or more files, and other data from a user of the model. In some examples, the user interface 222 is a keyboard, touchscreen, voice detector, or some other interface capable of receiving natural language user input data from a user. The user interface 222 may be included in an electronic device including the processor 224 of the trained model. However, in other examples the user interface 222 may be included a remote device that is configured to communicate with the trained model system 220 to provide the user input data to the model system.

A shared memory 230 is provided for exchanging data between the trained model and the drift detection system, such as datasets created during the processing of the trained model 220 and drift detection reports. Shared memory 230 may also store and/or facilitate communication of retraining instructions generated by drift detection system 200. For instance, the shared memory 230 may be configured to receive data from and/or transmit data to the drift detection system 200 via the network communication interface 202. Further, the shared memory 230 may be configured for receiving data from and/or transmitting data to the trained model system 220 via a network communication interface 226. In some examples, the shared memory 230 may be configured to communicate with external devices and/or networks, such as remote computing devices, servers, and cloud storage systems. The shared memory 230 may be interrogated (e.g., by an administrator or developer of the trained model system 220) to access information stored in the shared memory, such as various datasets received from the trained model system 220 and drift detection reports received from the drift detection system 200.

In some examples, the shared memory 230 includes a buffer window 232, which may be a dedicated memory for storing data received from the trained model system 220, such as one or more datasets 233 associated with the operations of the model system. The buffer window 232 may include memory having a buffer limit designating an amount of data storable by the shared memory 230 at a particular point in time. In some examples, the buffer limit represents the amount of data included in a single dataset that can be received and analyzed by the drift detection system 200 for the determination of concept drift and/or concept evolution. In some examples, the buffer window 232 represents a maximum amount of data that can be received from the trained model system 220 and stored in the shared memory 230 before the data is transmitted to the drift detection system 200. Accordingly, once a complete dataset 233 has been received in the buffer window, the dataset 233 may be transferred to the drift detection system 200 for drift detection operations.

As described elsewhere herein, trained model system 220 may execute a trained model and may provide output data regarding model execution to shared memory 230. When buffer window 232 in shared memory 230 is filled, the dataset stored in buffer window 232 may be transmitted to drift detection system 200, which may apply one or more drift detection algorithms to determine whether drift detection has occurred based on the data received regarding execution of the trained model. Based on determinations made by drift detection system 200 as to whether or not drift detection has occurred, a drift detection report 234 may be generated and/or instructions may be transmitted to trained model system 220 for retraining of the trained model executed by trained model system 220.

### Example: Concept Evolution

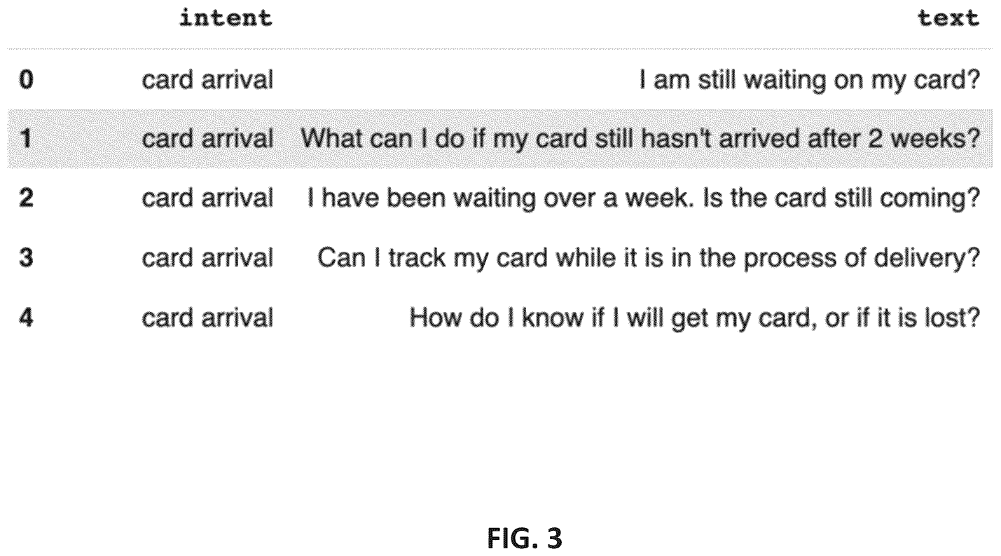

FIGS. 3-7 illustrate various aspects of an exemplary experiment conducted to establish that concept evolution has occurred with respect to the intent classifications provided to a chatbot in a training dataset. The experiment sought to replicate the classification of user inputs into a chatbot used by a bank to answer a user's queries about various banking services, such as credit and debit card related queries.

In the experiment, a chatbot was trained used a “banking77” dataset including a number of natural language user inputs labeled with one or more of 77 intent classifications. FIG. 3 illustrates a portion of an exemplary training dataset, including a plurality of exemplary user queries labeled with an associated intent classification. The user queries are shown in the column labeled “text”, and the associated intent classification is shown in the column labeled “intent”. The user queries in the training dataset related broadly to physical card-related queries from users. As seen in FIG. 3, user queries such as “I am still waiting on my card?” and “Can I track my card while it is in the process of delivery” are associated with the intent classification of “card arrival”. By training the model with the banking77 dataset, the chatbot will create associations between the various physical card-related user queries (and/or vectors representations of the user queries) and the 77 intent classifications provided in the training dataset.

To recreate a drift detection system, the experiment then generated new datasets including new user queries corresponding to various drifted and evolved intent classification categories. A first “base class” set of user queries related to physical card-related user queries, similarly to the initial dataset the chatbot was trained on. A second “drifted class” set of user queries related to disposable card-related queries, a concept that is relevant to the base class physical card-related queries, but having a changed distribution of user queries compared to the training dataset. A third “new concept” set of user queries related to foreign exchange-related queries, a concept that is a completely new topic and was unanticipated and unrepresented in the training dataset.

When the chatbot was deployed in production, the chatbot received user queries relating to one of the three classes specified above and categorized the queries the various user queries into one or more of the 77 intent classifications provided by the training dataset. When the base class set of user queries was input into the chatbot, the chatbot correctly classified the queries into the existing intent classifications, as the base class resembled the training dataset used to the train the model. To demonstrate degradation of model performance responsive to drifting user queries, the drifted class set of user queries about disposable cards was input into the chatbot. The performance of the chatbot degraded responsive to these queries, as the queries were similar to queries in the training dataset, but had a slightly different intent classification distribution that the chatbot had not previously encountered in the training dataset. Finally, to demonstrate concept evolution, the new concept set of user queries were input into the chatbot to determine the effect of the new concept user queries on the distribution of intent classifications recognized by the chatbot.

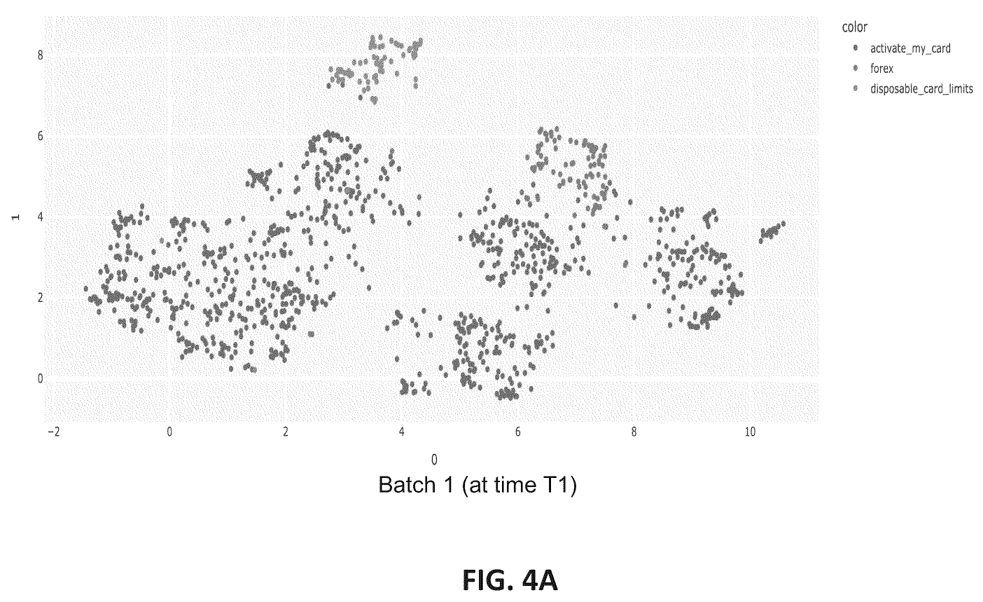

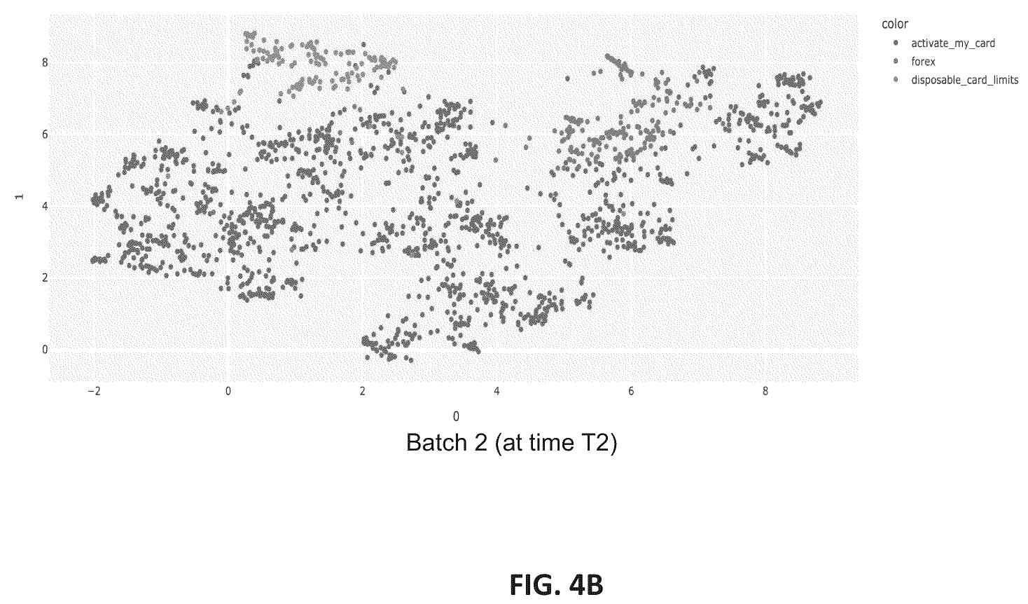

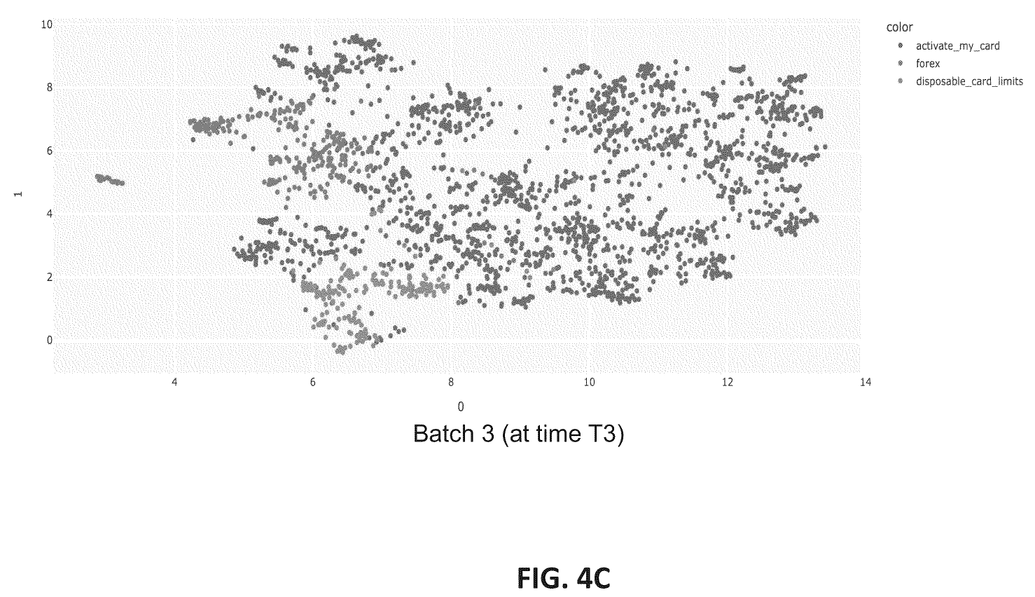

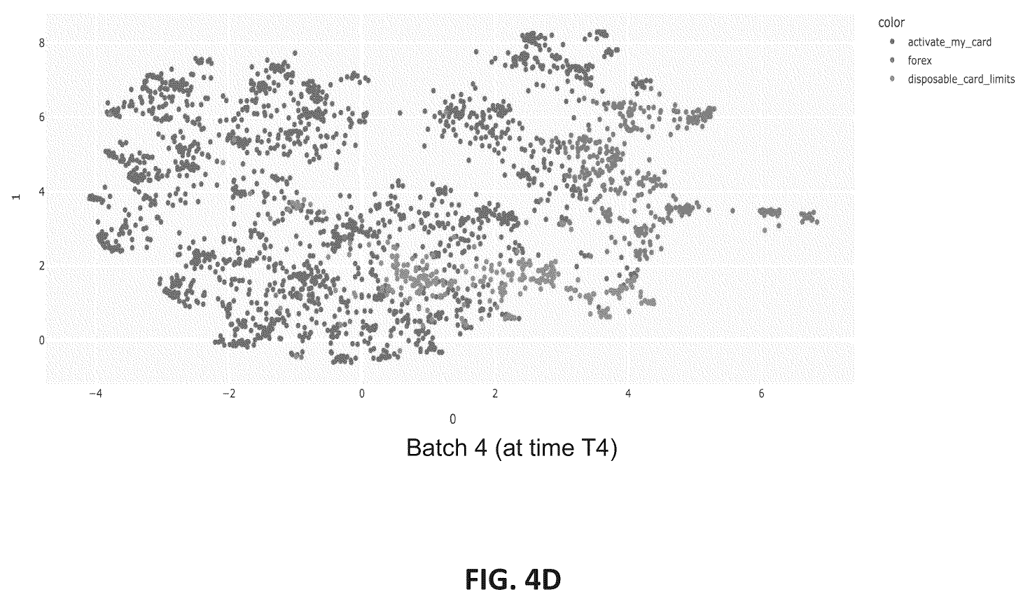

In a concept evolution detection experiment, the new base class, drifted class, and new concept datasets were divided into four equal batches for batchwise processing by the chatbot. Each of the batches included an equal proportion of the user queries from the base class, the drifted class, and the new concept class. The batchwise processing of the data was intending to recreate the batchwise processing of a drift detection system (e.g., the processing of various datasets representing particular periods of time, such as a first batch representing a first dataset collected between time t0 and time t1, a second batch representing a second dataset collected during time t1 and t2, and so forth). After each batch was input into the chatbot, the user queries were visualized in a two-dimensional distribution, wherein the location of a user query in the distribution is indicative of a likely intent classification associated with the user query. The user queries form clusters in the two-dimensional space, with each cluster being associated with an intent classification of the user query, which may be one of the 77 intent classifications included in the training dataset or an entirely new intent classification existing only in the batched datasets but not in the training dataset. FIG. 4A illustrates the spatial distribution of the user queries in the first batch dataset. FIG. 4B illustrates the spatial distribution of the user queries in the second batch dataset. FIG. 4C illustrates the spatial distribution of the user queries in the third batch dataset. FIG. 4D illustrates the spatial distribution of the user queries in the fourth batch dataset.

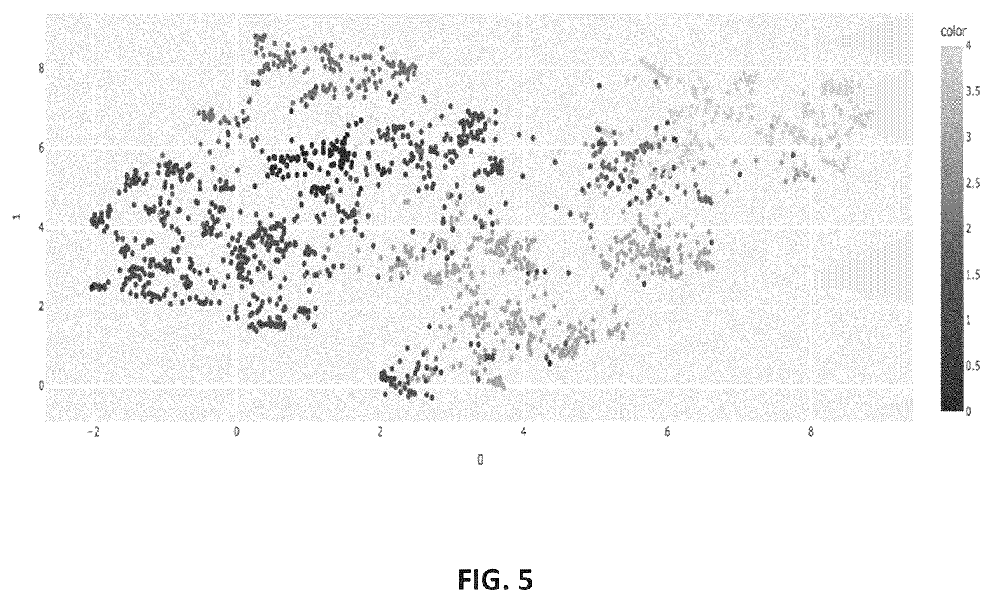

A spatial clustering analysis can then be performed on each batch of user queries to determine the relative fit of the dataset within the existing intent classifications recognized by the chatbot and included in the training dataset. FIG. 5 illustrates a spatial clustering analysis of the user query dataset included in the third batch, where the color of the various user query datapoints in the dataset represents the similarity between the datapoint and an existing intent classification of the training dataset. As seen in FIG. 5, the datapoints closest to the cluster formed by the base class user queries (e.g., physical card-related or card activation-related user queries) are colored more darkly than the datapoints representing the drifted class user queries (e.g., the disposable card-related user queries), which are farther from the clusters representing the training dataset intent classifications. The lightest colored datapoints correspond to the new concept user queries, which are not closely associated with any of the existing clusters representing the intent classifications in the training dataset.

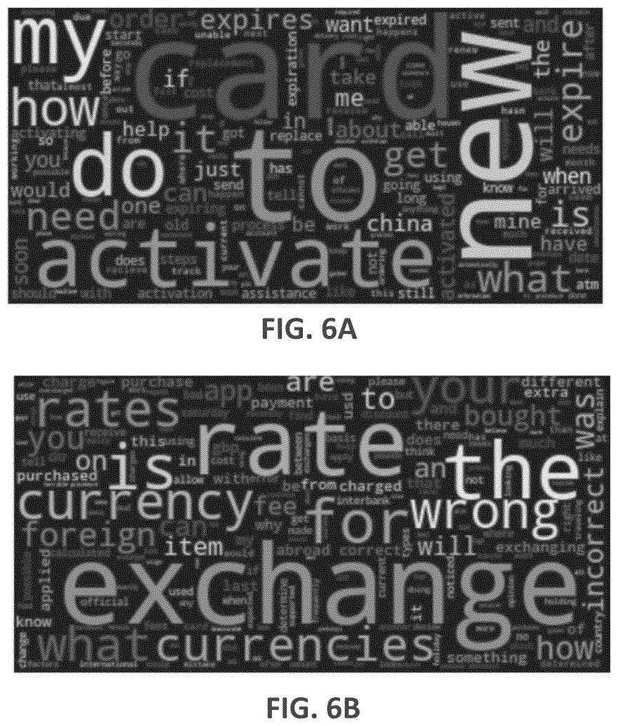

Each cluster in the spatial clustering analysis was then used to generate a word cloud representing the most common words present in each of the user queries in the cluster. For instance, FIG. 6A illustrates a word cloud corresponding to a cluster formed by the base class user queries in the dataset, and includes common words associated with physical cards, such as “activate”, “card”, and “new”. FIG. 6B illustrates a word cloud corresponding to a cluster formed by an anomalous class of user queries, which may represent user queries from the new concept dataset, that are distributed in a new cluster representing an intent classification that was not present in the training dataset. The word cloud may include common words associated with foreign exchange of currency, such as “exchange”, “rate”, and “currency”. Based on the word clouds, a new intent classification can be determined that accurately represents the user queries forming the new cluster. The new intent classification pertaining to the anomalous class of user queries may be determined manually by a human, or may be determined automatically using similarity metrics that compares the similarity of the anomalous class with the base class (e.g., using KS divergence testing).

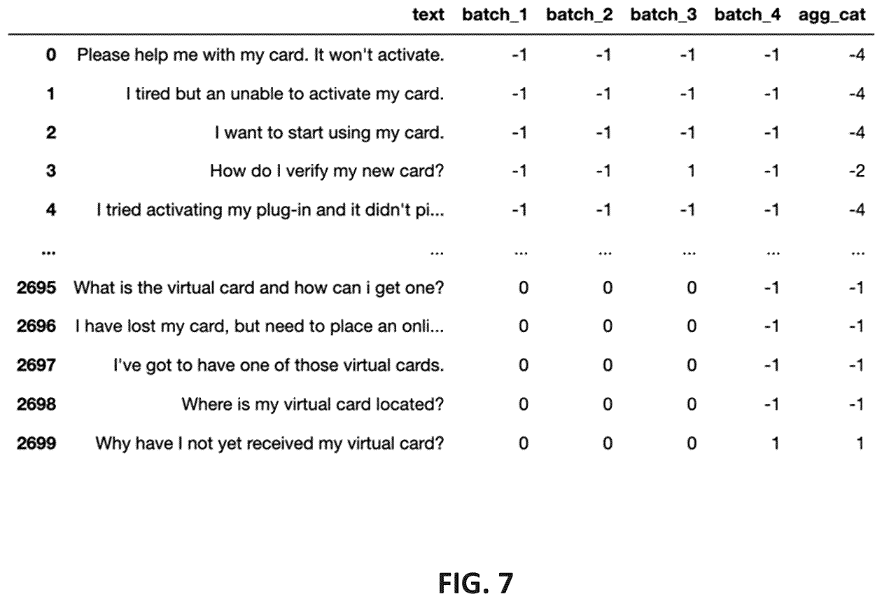

For each user query across the four dataset batches, a table can be populated including the query ID, a determination of whether the user query belongs in a base class cluster (e.g., a physical card cluster) or an anomalous cluster (e.g., a cluster formed by the new concept dataset, such as a foreign exchange cluster). FIG. 7 illustrates a table showing an analysis of various user queries included in the batched datasets. User queries pertaining to a base class cluster are designated with a “4” in the batch columns, while user queries pertaining to an anomalous class cluster are designated with “1”. Queries not included in a particular batch are designated with a “0”. Based on the word cloud analysis and the table, the queries can then be grouped together and input into LDA for prediction of a new intent class relating to the user queries in the anomalous class. Alternatively, a trained model (e.g., a trained model different from the particular chatbot used for the experiment) may be used to determine an intent classification of the user queries in the anomalous class.

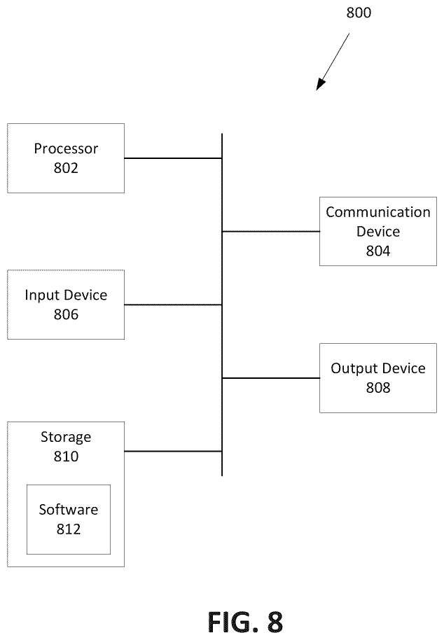

FIG. 8 depicts an exemplary computing device 800, in accordance with one or more examples of the disclosure. Device 800 can be a host computer connected to a network. Device 800 can be a client computer or a server. As shown in FIG. 8, device 800 can be any suitable type of microprocessor-based device, such as a personal computer, workstation, server, or handheld computing device (portable electronic device) such as a phone or tablet. The device can include, for example, one or more of processors 802, input device 806, output device 808, storage 810, and communication device 804. Input device 806 and output device 808 can generally correspond to those described above and can either be connectable or integrated with the computer.

Input device 806 can be any suitable device that provides input, such as a touch screen, keyboard or keypad, mouse, or voice-recognition device. Output device 808 can be any suitable device that provides output, such as a touch screen, haptics device, or speaker.

Storage 810 can be any suitable device that provides storage, such as an electrical, magnetic, or optical memory, including a RAM, cache, hard drive, or removable storage disk. Communication device 804 can include any suitable device capable of transmitting and receiving signals over a network, such as a network interface chip or device. The components of the computer can be connected in any suitable manner, such as via a physical bus or wirelessly.

Software 812, which can be stored in storage 810 and executed by processor 802, can include, for example, the programming that embodies the functionality of the present disclosure (e.g., as embodied in the devices as described above).

Software 812 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 810, that can contain or store programming for use by or in connection with an instruction execution system, apparatus, or device.

Software 812 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Device 800 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 800 can implement any operating system suitable for operating on the network. Software 812 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A method for monitoring concept drift in a trained model, the method comprising:
receiving a first dataset representing model operations executed by the trained model;
applying a data processing operation to the first dataset to determine a first result data based on the first dataset;
determining, based on the first result data, a difference between the first result data and a second result data;
determining, based on the difference, whether concept drift has occurred; and
in accordance with a determination that concept drift has occurred, transmitting an instruction to update training of the trained model.

2. The method of claim 1, wherein the data processing operation comprises a statistical analysis operation and wherein the first result data comprises a first statistical output.

3. The method of claim 2, wherein the statistical analysis operation comprises one or more of the following: a Kolmogorov-Smirnov (KS) test, a maximum mean discrepancy (MMD) test, a least-squares density difference (LSDD) test, a KMeans and chi square test, an equal intensity KMeans (EIKMeans) and chi square test, a Jensen-Shannon (JS) divergence test, and an uncertainty classifier.

4. The method of claim 1, wherein the data processing operation comprises a model error rate determination analysis and wherein the first result data comprises a first error rate.

5. The method of claim 4, wherein the model error rate determination analysis comprises one or more of the following: Fisher's test, and a statistical test of equal proportions (STEPD).

6. The method of claim 1, wherein the first dataset comprises at least one of user input data, vector data representative of the user input data, and model output data.

7. The method of claim 6, wherein the user input data comprises natural language data.

8. The system of claim 6, wherein the model output data comprises an intent classification generated based on user input data of the first dataset.

9. The method of claim 1, wherein receiving the first dataset comprises receiving the first dataset from a shared memory in communication with the trained model.

10. The method of claim 1, wherein the first dataset comprises a predetermined amount of data.

11. The method of claim 1, wherein the first dataset comprises data received during a predetermined period of time.

12. The method of claim 1, wherein the method further comprises:
receiving a second dataset representing model operations executed by the trained model; and
applying a data processing operation to the second dataset to determine the second result data.

13. The method of claim 12, wherein the second dataset comprises a training dataset that was used to train the trained model.

14. The method of claim 12, wherein the second dataset comprises a dataset having a similar distribution to a training dataset that was used to train the trained model.

15. The method of claim 12, wherein the second dataset comprises an inference dataset processed by the trained model at a different time than the first dataset.

16. The method of claim 1, wherein the difference comprises a difference between a first characteristic of the first result data and a second characteristic of the second result data.

17. The method of claim 1, wherein the difference comprises a difference between a first determined number of clusters of the first dataset and a second determined number of clusters in a second dataset.

18. The method of claim 1, wherein determining whether concept drift has occurred comprises determining whether the difference is greater than a threshold value.

19. The method of claim 1, wherein transmitting the instruction to update training of the trained model comprises transmitting executable program code configured to cause the trained model to be retrained when the code is executed by one or more processor.

20. The method of claim 1, wherein the instruction comprises an indication of the character or magnitude of the detected concept drift.

21. The method of claim 1, wherein the method further comprises:
retraining the trained model, wherein retraining the trained model comprises:
applying one or more labels to data in the first dataset, the one or more labels associated with an intent classification of the data; and
updating the trained model based at least in part on the labeled first dataset.

22. The method of claim 21, wherein the one or more labels applied to the data are determined based on a spatial clustering analysis of the first dataset.

23. The method of claim 1, wherein the trained model is a chatbot.

24. A system for monitoring concept drift in a trained model, the system comprising one or more processors configured to cause the system to:
receive a first dataset representing model operations executed by the trained model;
apply a data processing operation to the first dataset to determine a first result data based on the first dataset;
determine, based on the first result data, a difference between the first result data and a second result data;
determine, based on the difference, whether concept drift has occurred; and
in accordance with a determination that concept drift has occurred, transmit an instruction to update training of the trained model.

25. A non-transitory computer readable storage medium storing one or more programs, the one or more programs comprising instructions, which when executed by one or more processors of an electronic device, cause the electronic device to:
receive a first dataset representing model operations executed by the trained model;
apply a data processing operation to the first dataset to determine a first result data based on the first dataset;
determine, based on the first result data, a difference between the first result data and a second result data;
determine, based on the difference, whether concept drift has occurred; and
in accordance with a determination that concept drift has occurred, transmit an instruction to update training of the trained model.
